(19) United States
(12) Patent Application Publication
(10) Pub. No.: US 2025/0002399 A1
(43) Pub. Date: Jan. 2, 2025

(54) WET ETCHING OF HIGH INDEX GLASS FOR SURFACE STRENGTH IMPROVEMENT

(71) Applicant: CORNING INCORPORATED, CORNING, NY (US)

(72) Inventors: Jiangwei Feng, Newtown, PA (US); Timothy James Orcutt, Corning, NY (US); Shai Negev Shafrir, Rochester, NY (US); Istvan Laszlo Szabo, Bath, NY (US)

(21) Appl. No.: 18/735,717

(22) Filed: Jun. 6, 2024

Related U.S. Application Data
(60) Provisional application No. 63/523,681, filed on Jun. 28, 2023.

(51) Int. Cl. C03C 15/02; C03C 3/155; C03C 23/00

(52) U.S. Cl. CPC C03C 15/02; C03C 3/155; C03C 23/0075

(57) ABSTRACT

Methods for making a glass article include etching the surfaces of the glass article with an etchant solution that includes hydrofluoric acid to produce an etched glass article. The glass article being a high index glass containing transition metal oxides and having an index of refraction greater than or equal to about 1.6 at 589.3 nm wavelength. The surface having surface and subsurface defects. The etching improves a surface strength of the surfaces of the etched glass article by removing or rounding the surface and subsurface defects, and the etching causes deposition of transition metal fluorides. The methods include cleaning the surfaces of the etched glass article with a cleaning solution having a pH of greater than or equal to about 10 to remove transition metal fluorides from the surfaces of the etched glass article.

This application claims the benefit of priority under 35 U.S.C § 120 of U.S. Provisional Application Ser. No. 63/523,681 filed on Jun. 28, 2023, the content of which is relied upon and incorporated herein by reference in its entirety.

### BACKGROUND

### Field

The present specification generally relates to glass, and particularly to methods of producing high refractive index glass articles.

### Technical Background

Glass is used in a variety of optical devices, examples of which include augmented reality devices, virtual reality devices, mixed reality devices, eyewear, etc. Desirable properties for this type of glass often include a high refractive index and a low density. Additional desirable properties may include high transmission in the visible and near-ultraviolet (“near-UV”) range of the electromagnetic spectrum and/or low optical dispersion. It can be challenging to find glasses that have the desired combination of these properties and that can be formed from compositions having good glass-forming ability.

### SUMMARY

A first aspect of the present disclosure may be directed to a method of making a glass article, the method comprising etching at least one surface of a glass article with an etchant solution comprising hydrofluoric acid (HF) to produce an etched glass article, the glass article comprising a high index glass, the high index glass comprising transition metal oxides and having an index of refraction of greater than or equal to about 1.60 at a wavelength of 589.3 nm, the at least one surface comprising surface and subsurface defects. The etching may improve a surface strength of the at least one surface of the etched glass article by removing or rounding the surface and subsurface defects. The etching may cause the deposition of transition metal fluorides onto the at least one surface of the etched glass article. The method may further include cleaning the at least one surface of the etched glass article with a high pH cleaning solution having a pH of greater than or equal to about 10.0, wherein the cleaning solution removes the transition metal fluorides from the at least one surface of the etched glass article.

A second aspect disclosed herein may include the first aspect, wherein the etchant solution may comprise from about 1.0 molar (M) to about 8.0 M HF.

A third aspect disclosed herein may include either one of the first or second aspects, wherein the etchant solution may further comprise one or more of HCl, H₂SO₄, or HNO₃.

A fourth aspect disclosed herein may include the third aspect, wherein the etchant solution may comprise from about 2.0 M to about 10.0 M HCl, H₂SO₄, HNO₃, or any combination thereof.

A fifth aspect disclosed herein may include any one of the first through fourth aspects, wherein the etchant solution may comprise HF and HCl in a molar ratio of HF to HCl of from about 1.0 to about 3.0, or from about 1.5 to about 2.0.

A sixth aspect disclosed herein may include any one of the first through fifth aspects, wherein an etch rate of the etching may be from about 0.01 μm/sec to about 0.5 μm/sec.

A seventh aspect disclosed herein may include any one of the first through sixth aspects, wherein the etching may remove from about 1 μm to about 10 μm of glass from the at least one surface of the etched glass article.

An eighth aspect disclosed herein may include any one of the first through seventh aspects, wherein a temperature of the etching may be from about 20° C. to about 45° C., or about 25° C.

A ninth aspect disclosed herein may include any one of the first through eighth aspects, wherein the high pH cleaning solution may comprise ammonium hydroxide, NaOH, KOH, a high pH glass cleaning detergent, or combinations thereof.

A tenth aspect disclosed herein may include any one of the first through ninth aspects, wherein the cleaning the etched glass article may comprise submerging the etched glass article in the high pH cleaning solution at a temperature of from about 55° C. to about 70° C. for a contact duration of from about 5 minutes to about 20 minutes.

An eleventh aspect disclosed herein may include any one of the first through tenth aspects, wherein the transition metal fluorides may comprise LaF₃ and the contacting the etched glass article with the high pH cleaning solution may remove the LaF₃ deposited onto the at least one surface of the etched glass article.

A twelfth aspect disclosed herein may include any one of the first through eleventh aspects, further comprising polishing the at least one surface of the etched glass article with colloidal silica or with a slurry of Al₂O₃ or ZrO₂ to produce a finished glass article.

A thirteenth aspect disclosed herein may include any one of the first through twelfth aspects, wherein the at least one surface of the finished glass article may have a root mean square roughness of less than or equal to about 0.5 nm as measured by atomic force microscopy.

A fourteenth aspect disclosed herein may include any one of the first through thirteenth aspects, wherein the surface and subsurface defects on the at least one surface of the glass article after forming and before etching may limit a B₁₀ surface strength of the at least one surface of the glass article to less than or equal to about 250 N, as determined from a ring-on-ring (RoR) test according to ASTM: C1499-09.

A fifteenth aspect disclosed herein may include any one of the first through fourteenth aspects, wherein the etching may increase the B₁₀ surface strength of the at least one surface of the etched glass article by at least about 50% compared to the glass article before the etching.

A sixteenth aspect disclosed herein may include any one of the first through fifteenth aspects, wherein the high index glass may comprise greater than or equal to about 30.0 mol % transition metal oxides.

A seventeenth aspect disclosed herein may include any one of the first through sixteenth aspects, wherein the transition metal oxides may comprise one or more metal oxides selected from lanthanum oxide, niobium oxide, tungsten oxide, or combinations thereof.

An eighteenth aspect disclosed herein may include any one of the first through seventeenth aspects, wherein the high index glass may comprise from about 10.0 mol % to about 40.0 mol % B₂O₃, from greater than or equal to 0 mol % to about 40.0 mol % WO3, from greater than or equal to 0 mol % to about 30.0 mol % Nb₂O₅, from greater than or equal to 0 mol % to about 30.0 mol % TiO₂, from greater than or equal to 0 mol % to about 25.0 mol % La₂O₃, and from greater than or equal to 0 mol % to about 15.0 mol % ZrO₂, based on the total moles of the high index glass.

A nineteenth aspect disclosed herein may include any one of the first through eighteenth aspects, wherein the high index glass may comprise greater than about 15.0 mol % La₂O₃.

A twentieth aspect disclosed herein may include any one of the first through nineteenth aspects, wherein the transition metal fluorides may comprise LaF₃.

A twenty-first aspect disclosed herein may include any one of the first through twentieth aspects, wherein the high index glass does not include silica.

A twenty-second aspect disclosed herein may include any one of the first through twenty-first aspects, wherein the high index glass may comprise less than or equal to about 1 mol % silica.

A twenty-third aspect disclosed herein may include any one of the first through twenty-second aspects, further comprising forming the glass article.

A twenty-fourth aspect disclosed herein may include the twenty-third aspect, wherein the forming the glass articles may comprise melting a batch of glass precursor raw materials to form a molten high index glass, forming a high index glass substrate from the molten high index glass, separating the high index glass substrate into a plurality of individual glass articles, and refining the plurality of individual glass articles to produce a plurality of refined glass articles.

A twenty-fifth aspect disclosed herein may include the twenty-fourth aspect, wherein forming the high index glass substrate from the molten high index glass may comprise forming the high index glass substrate using a slot draw process.

A twenty-sixth aspect disclosed herein may include either one of the twenty-fourth or twenty-fifth aspects, wherein separating the high index glass substrate may comprise cutting the high index glass substrate into the plurality of individual glass articles with a cutting tool.

A twenty-seventh aspect disclosed herein may include any one of the twenty-fourth through twenty-sixth aspects, wherein the refining the plurality of individual glass articles may comprise lapping, edge shaping, polishing, cleaning, or combinations thereof.

A twenty-eighth aspect disclosed herein may include any one of the twenty-fourth through twenty-seventh aspects, comprising a glass article produced by the methods of any one of the first through twenty-fourth aspects.

A twenty-ninth aspect disclosed herein may include the twenty-eighth aspect, comprising a surface layer at the at least one surface of the glass article, wherein the surface layer may have a thickness of from about 1 nm to about 20 nm and the surface layer may have a greater concentration of ZrO₂, hydrogen, or both compared to a concentration of ZrO₂, hydrogen, or both, respectively, in the bulk of the glass article.

A thirtieth aspect disclosed herein may include any one of the first through twenty-ninth aspect, wherein the cleaning solution has a pH of greater than or equal to about 11.0, greater than or equal to about 12.0.

A thirty-first aspect disclosed herein may be directed to a glass article comprising a high index glass, the high index glass may comprise greater than about 10.0 mol % La₂O₃ and may have a refractive index greater than about 1.60 at a wavelength of 589.3 nm, the glass article may have at least one surface with a B₁₀ surface strength, as determined from a ring-on-ring (RoR) test according to ASTM: C1499-09, greater than 250 N, or greater than 300 N, or greater than 400 N, or greater than 500 N.

A thirty-second aspect disclosed herein may include the thirty-first aspect, wherein the high index glass further may comprise greater than about 20.0 mol % B₂O₃.

A thirty-third aspect disclosed herein may include either one of the thirty-first or thirty-second aspects, wherein the high index glass further may comprise greater than about 4.0 mol % ZrO₂.

A thirty-fourth aspect disclosed herein may include any one of the thirty-first through thirty-third aspects, wherein the high index glass further may comprise greater than about 5.0 mol % TiO₂.

A thirty-fifth aspect disclosed herein may include any one of the thirty-first through thirty-fourth aspects, wherein the high index glass further may comprise greater than about 10.0 mol % Nb₂O₅.

A thirty-sixth aspect disclosed herein may include any one of the thirty-first through thirty-fifth aspects, wherein the high index glass further may comprise greater than about 10.0 mol % WO3.

A thirty-seventh aspect disclosed herein may include any one of the thirty-first through thirty-sixth aspects, wherein the B₁₀ surface strength may be greater than or equal to 300, or greater than 500 N.

A thirty-ninth aspect disclosed herein may include any one of the thirty-first through thirty-eighth aspects, wherein the at least one surface of the glass article may comprise a surface layer having a thickness of from 1 nm to 20 nm, wherein the surface layer may have a concentration of ZrO₂, hydrogen, or both that is greater than a concentration of ZrO₂, hydrogen, or both, respectively, in the bulk of the glass article.

Additional features and advantages of the methods and glass articles disclosed herein will be set forth in the detailed description, which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a cross-section of a portion of a glass article manufactured using conventional methods, according to the prior art;

FIG. 2 graphically depicts a Weibull plot of a surface strength of a high refractive index (“HRI”) glass article manufactured using conventional methods, according to the prior art;

FIG. 3 is a flow chart of a method for producing high refractive index (HRI) glass articles, according to embodiments shown and described herein;

FIG. 4 graphically depicts waveguide loss of an HRI glass article manufactured using conventional methods with no etching and an HRI glass article after etching and cleaning, according to embodiments shown and described herein;

FIG. 5 graphically depicts an x-ray diffraction (“XRD”) pattern of a surface of an etched glass article following etching with an etchant solution comprising HF, according to embodiments shown and described herein;

FIG. 6 graphically depicts an elemental analysis from x-ray diffraction (“XRD”) for the surface of the etched and cleaned glass article of FIG. 5, according to embodiments shown and described herein;

FIGS. 7A and 7B are scanning electron microscope (“SEM”) images of the precipitate formed on the surface of an HRI glass article after etching, according to embodiments shown and described herein;

FIG. 8 is an SEM image of a surface of an etched and cleaned glass article after cleaning with a cleaning solution, according to embodiments shown and described herein;

FIG. 9 graphically depicts an elemental analysis from x-ray diffraction (“XRD”) for the surface of the etched and cleaned glass article of FIG. 8, according to embodiments shown and described herein;

FIG. 10 graphically depicts a Weibull plot of surface strength of HRI glass articles after etching and cleaning, according to embodiments shown and described herein;

FIG. 11 graphically depicts a crack depth of HRI glass articles etched to varying depths, according to embodiments shown and described herein;

FIG. 12 depicts secondary ion mass spectrometry (“SIMS”) depth profiles of Zr in HRI glass articles after etching and cleaning, according to embodiments shown and described herein;

FIG. 13 graphically depicts haze, surface roughness, etch depth, and reflective diffusion as measured for HRI glass articles etched with different etchant solutions and contacted with the etchant solutions for different etching times, according to embodiments shown and described herein;

FIG. 14 depicts a surface of an HRI glass article etched with an etchant solution comprising an HF/HCl molarity ratio from 1.5 to 2, according to embodiments shown and described herein;

FIG. 15 depicts a surface of an HRI glass article etched with an etchant solution comprising an HF/HCl molarity ratio of greater than 2, according to embodiments shown and described herein;

FIG. 16 depicts a surface of an HRI glass article etched with an etchant solution comprising an HF/HCl molarity ratio equal to 1, according to embodiments shown and described herein; and

FIG. 17 depicts a surface of an HRI glass article etched with an etchant solution comprising an HF/HCl molarity ratio of less than 1, according to embodiments shown and described herein.

### DETAILED DESCRIPTION

Reference will now be made in detail to embodiments of methods of making glass articles and the glass articles made by the methods disclosed herein, various embodiments of which will be described herein with specific reference to the accompanying drawings. Whenever possible, the same reference numerals will be used throughout the drawings to refer to the same or like parts. The present application is directed to methods for making high refractive index (HRI) glass articles and the HRI glass articles made by the method. The methods disclosed herein may comprise forming a glass article from a high index glass comprising transition metal oxides and having an index of refraction of greater than or equal to about 1.60 at a wavelength of light of 589.3 nm. After forming the glass article, at least one surface of the glass article comprises surface and subsurface defects. The methods may further comprise etching the at least one surface of the formed glass article with an etchant solution to produce an etched glass article. The etching may improve a surface strength of the at least one surface of the etched glass article by removing or rounding the surface and subsurface defects. In embodiments, the etching may cause the deposition of transition metal fluorides onto the at least one surface of the etched glass article. The methods may further comprise cleaning the at least one surface of the etched glass article with a high pH cleaning solution having a pH of greater than or equal to about 10.0. The cleaning solution may remove the transition metal fluorides from the at least one surface of the etched glass article. The present application is also directed to glass articles made from the methods disclosed herein.

The methods described herein have been shown to be highly effective in improving surface and edge strength after wet etching by reducing subsurface damage. Moreover, the disclosed methods for making HRI glass articles are scalable and compatible with current glass wet etching processes and can easily be incorporated into finishing processes to achieve a targeted mechanical and optical performance in the completed glass parts, among other features.

In the following detailed description, numerous specific details may be set forth in order to provide a thorough understanding of embodiments described herein. However, it will be clear to one skilled in the art when embodiments may be practiced without some or all of these specific details. In other instances, well-known features or processes may not be described in detail so as not to unnecessarily obscure the disclosure. In addition, like or identical reference numerals may be used to identify common or similar elements. Moreover, unless otherwise defined, all technical and scientific terms used herein have the same meaning as commonly understood by one of ordinary skill in the art to which this disclosure belongs. In case of conflict, the present specification, including the definitions herein, will control.

Although other methods and materials can be used in the practice or testing of the embodiments, certain suitable methods and materials are described herein.

Disclosed are materials, compounds, compositions, and components that can be used for, can be used in conjunction with, can be used in preparation for, or are embodiments of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein.

Thus, if a class of substituents A, B, and C are disclosed as well as a class of substituents D, E, and F, and an example of a combination embodiment, A-D is disclosed, then each is individually and collectively contemplated. Thus, in this example, each of the combinations A-E, A-F, B-D, B-E, B-F, C-D, C-E, and C-F are specifically contemplated and should be considered disclosed from disclosure of A, B, and/or C; D, E, and/or F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and/or C; D, E, and/or F; and the example combination A-D. This concept applies to all aspects of this disclosure including, but not limited to any components of the compositions and steps in methods of making and using the disclosed compositions. More specifically, the example composition ranges given herein are considered part of the specification and further, are considered to provide example numerical range endpoints, equivalent in all respects to their specific inclusion in the text, and all combinations are specifically contemplated and disclosed. Further, if there are a variety of additional steps that can be performed it is understood that each of these additional steps can be performed with any specific embodiment or combination of embodiments of the disclosed methods, and that each such combination is specifically contemplated and should be considered disclosed.

Moreover, where a range of numerical values is recited herein, comprising upper and lower values, unless otherwise stated in specific circumstances, the range is intended to include the endpoints thereof, and all integers and fractions within the range. It is not intended that the scope of the disclosure be limited to the specific values recited when defining a range. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. Finally, when the term “about” is used in describing a value or an end-point of a range, the disclosure should be understood to include the specific value or end-point referred to.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. For purposes of the present disclosure, the term “about” when used in reference to a numerical value means the numerical value is within a range defined by +3 of the last decimal place of the numerical value. For example, the numerical value “about 10.0” means a value between 9.7 and 10.3.

It is noted that one or more of the claims may utilize the term “wherein” as a transitional phrase. For the purposes of defining the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

As a result of the raw materials and/or equipment used to produce the glass compositions discussed herein, certain impurities or components that are not intentionally added, can be present in the final glass composition. Such materials are present in the glass composition in minor amounts and are referred to herein as “tramp materials.”

As used herein, “refractive index” (or “index of refraction”) refers to the refractive index at a wavelength of 589.3 nm, which is known in the art as np. The terms “high refractive index”, “high index of refraction”, “high index”, and “HRI” refer to a refractive index greater than or equal to about 1.60.

As used herein, the term “high pH” refers to a pH greater than or equal to about 10.0.

As used herein, a glass composition having 0 (zero) mol % or 0 wt. % of a compound is defined as meaning that the compound, molecule, or element was not purposefully added to the composition, but the composition may still comprise the compound, typically in tramp or trace amounts. Similarly, “iron-free,” “sodium-free,” “lithium-free,” “zirconium-free,” “alkali earth metal-free,” “heavy metal-free” or the like are defined to mean that the compound, molecule, or element was not purposefully added to the composition, but the composition may still comprise iron, sodium, lithium, zirconium, alkali earth metals, or heavy metals, etc., but in approximately tramp amounts.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation; and the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

Directional terms as used herein—for example up, down, right, left, front, back, top, bottom, vertical, horizontal—are made only with reference to the figures as drawn and are not intended to imply absolute orientation unless otherwise expressly stated.

Any ranges used herein include all ranges and subranges and any values there between unless explicitly stated otherwise.

Conventional methods for manufacturing glass articles comprising a high refractive index (HRI) glass (also referred to herein as “high index glass”) include the steps of melting a batch composition comprising a quantity of raw glass-forming materials to form a melt, forming a glass substrate (e.g. a sheet or block) from the melt, separating the glass substrate into a plurality of individual glass articles using a wire saw or other cutting tool or separating method, and refining the individual glass articles to produce refined glass articles. Refining the individual glass articles can include one or more post-processing steps, such as but not limited to, lapping, edge shaping, rough polishing, fine polishing, super polishing, and cleaning. “Lapping” refers to a process of applying an abrasive mixture to surfaces of the individual glass articles to polish the individual glass articles, and “edge shaping” refers to changing the shape of the edges of the individual glass articles with a wire saw. Rough polishing, fine polishing, and super polishing all refer to smoothing the surface, and cleaning refers to removing residual particular matter that may form on the surface due to other post-processing steps, such as but not limited to particulates used for the various polishing steps or glass particulates from edge shaping or other cutting process. Although these post-processing refining steps provide refined glass articles with good optical performance, the post-processing steps also impart significant surface and/or subsurface damage to the refined glass articles.

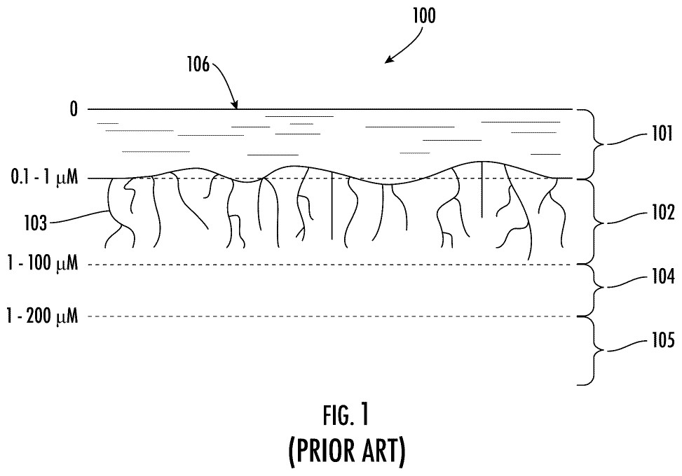

Referring now to FIG. 1, a cross-section of a portion of an HRI glass article 100 manufactured and refined as described above according to conventional methods is schematically depicted. The numerical values at the left side of FIG. 1 refer to depth in units of microns (μm) relative to a refined surface 106 of HRI glass article 100. The HRI glass article 100 has a surface layer 101 that is smooth, polished, and cleaned following post-processing refining. Just below the smooth and polished surface layer 101 is a defect layer 102 with micro-cracks 103. The micro-cracks 103 may be caused by processing or post-processing of the refined glass articles 100, such as by separating and shaping with wire saws or other cutting tools, refining, and/or handling the HRI glass article 100 between post-processing steps. The micro-cracks 103 can lead to the formation of a deformed layer 104 disposed beneath the defect layer 102. Thus, the first defect and deformation free layer 105 of the refined glass article 100 may be disposed at a depth of up to about 200 μm below the refined surface 106 of the surface layer 101.

The presence of surface and subsurface defects and the depth to which the surface and subsurface defects extend into the surface of the HRI glass article 100 can be determined from a chemical etching process. In the chemical etching process, a portion of the surface is covered with a mask to establish a zero point baseline for the depth. The exposed surface of the HRI glass article is then etched with an etchant solution discrete time periods (e.g., 1 minute to 10 minutes). The etchant solution can be any suitable etchant, but examples can include a solution of HF in water. At the end of each discrete time period, the etchant is removed, the surface cleaned, and the depth of etching is measured. The etching rate is calculated from the time period duration and the measured depth of etching as compared to the control surface covered by the mask. In the regions having surface and/or subsurface damage, the surface and/or subsurface damage has greater surface area and concentrated local stress, which both contribute to a greater etching rate compared to etching the bulk material with no or minimal defects. As the surface and/or subsurface defects are etched away, the etching rate decreases and eventually plateaus at a generally constant etching rate, which is generally equal to the etching rate of the bulk material having little or no defects. The depth of etching at which the etching rate plateaus correlates to the depth to which the surface and/or subsurface damage extends into the surface of the glass. Thus, the depth of the surface and/or subsurface damage can be estimated as the depth at which the etching rate becomes constant.

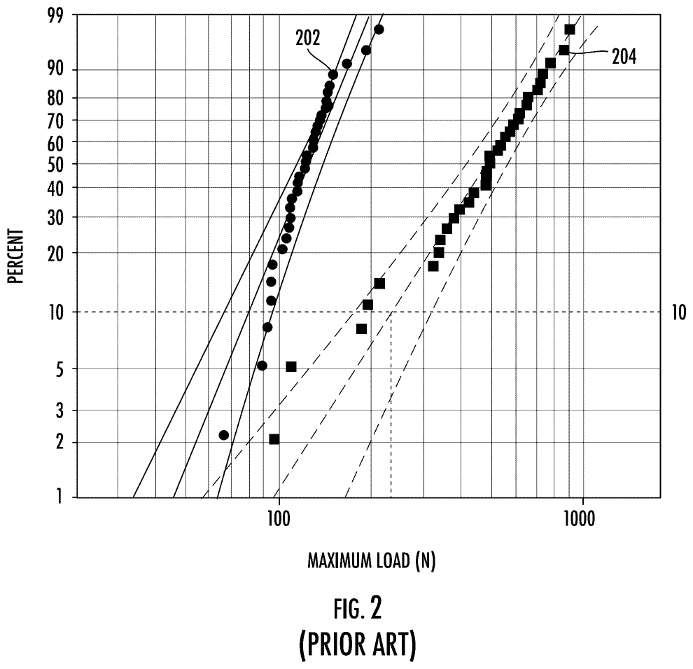

The defects in the HRI glass article 100 caused by post-processing may result in a decrease in a surface strength of the HRI glass article 100. Referring now to FIG. 2, a Weibull distribution plot of a refined HRI glass article 100 having the composition comprising B₂O₃ (33.00 mol %), TiO₂ (9.00 mol %), ZrO₂ (7.00 mol %), Nb₂O₅ (15.00 mol %), La₂O₃ (20.00 mol %), and WO3 (16.00 mol %). The Weibull distribution plot predicts the percentage of glass articles exhibiting fracture as a function of mechanical load for a ball-on-ball surface strength testing (ref. no. 202 in FIG. 2) and a ring-on-ring (RoR) surface strength testing (ref. no. 204 in FIG. 2). The RoR surface strength test data in FIG. 2 was determined according to the test method in ASTM: C1499-09, with a coupon having dimensions of 50 mm by 50 mm and a thickness of 0.6 mm. As shown in the plot, there is over a 10 percent chance that the HRI glass article 100 will fail when subjected to a 250 Newton (“N”) load in a ring-on-ring (“RoR”) type surface strength test. Thus, ongoing needs exist for producing HRI glass articles having greater surface strength while maintaining the optical properties of the HRI glass articles.

The term “B₁₀ surface strength” of a glass article refers to the load, as determined from a ring-on-ring (RoR) surface strength test defined by ASTM: C1499-09, in a Weibull distribution plot (such as FIG. 2), based on measurements of at least 20 samples, at which the glass article, when configured as a coupon having dimensions of 50 mm by 50 mm and a thickness of 0.6 mm, has a 10% or greater probability of fracturing.

The present application is directed to methods of making HRI glass articles with improved surface strength and the HRI glass articles made according to the disclosed methods. The methods disclosed herein include a wet-etching step that removes or “rounds out” the subsurface micro-cracks and other imperfections in the refined glass articles. Specifically, the disclosed methods involve subjecting a refined glass article comprising an HRI glass to an etchant solution comprising hydrofluoric acid (HF). The etchant solution may include other strong acids, such as but not limited to, hydrochloric acid (HCl), sulfuric acid (H₂SO₄), nitric acid (HNO₃), or any combination thereof.

When the surface of an HRI glass article is etched with an etchant solution that comprises HF, a layer of metal fluoride may deposit on the surface of the HRI glass article. Without being bound by any particular theory, it is believed that the HF in the etchant solution reacts with metal oxides (MOₙ) in the HRI glass to form metal fluorides (H₍ₓ₋₂ₙ₎MFₓ) and water, according to the Equation 1 (EQU. 1).

$$M {O}_{n} + x HF ⇔ {H}_{( x - 2 n )} {M F}_{x} + {n H}_{2} O \qquad EQU . 1$$

In general, the metal fluorides are hydrolyzed in aqueous acid according to Equation 2 (EQU. 2).

$${M F}_{x}^{( x - 2 n ) -} + {n H}_{2} O ⇔ {M O}_{n} + {x F}^{-} + 2 {n H}^{+} \qquad EQU . 2$$

However, at some point during the etching process, the solubility limits of some of the metal fluorides may be reached and, rather than hydrolyzing, these metal fluorides may precipitate and deposit onto the surfaces of the HRI glass article. Many HRI glass compositions, for example, contain lanthanum oxide. When treated with HF, lanthanum oxide may form lanthanum fluoride (LaF₃). The following Equation 3 shows the reaction of HF with the lanthanum oxide to produce LaF₃. Due to the extremely low solubility of LaF₃, the hydrated form of lanthanum fluoride (e.g., hydrolyzed LaF₃ according to EQU. 2) is unlikely.

$${La}_{2} {O}_{3} + 6 HF ⇔ 2 {LaF}_{3} + 3 {H}_{2} O \qquad EQU . 3$$

LaF₃ has low solubility in aqueous solution and is expected to be a metal fluoride that deposits on the surface of the HRI glass article during etching with the etchant solution comprising HF. The deposits of LaF₃ on the surfaces of the HRI glass articles can impede the optical performance of the HRI glass articles. Other metal fluorides with low solubility in aqueous solution may behave similarly. The present disclosure demonstrates that metal fluoride deposits can be removed by treating the etched surface of the etched glass article with a high pH cleaning solution, such as a cleaning solution having a pH of greater than about 10, greater than about 11, or even greater than about 12. Therefore, the methods disclosed herein may include, after etching the surfaces of the HRI glass articles with an etchant solution comprising HF, treating the surfaces with a high pH cleaning solution. Treating the surfaces of the glass articles with the high pH cleaning solution may remove the metal fluoride deposits from the surfaces of the glass articles.

Embodiments of the methods described herein have been shown to be highly effective in improving the B₁₀ surface strength and edge strength of the HRI glass articles after wet etching and subsequent cleaning, by reducing subsurface damage. Moreover, the disclosed methods are believed to be scalable and compatible with current glass wet etching processes and can easily be incorporated into finishing processes to achieve targeted mechanical and optical performance in the finished HRI glass articles, among other features.

The methods disclosed herein comprise forming a glass article from a high index glass comprising transition metal oxides and having an index of refraction of greater than or equal to about 1.60, such as from about 1.60 to about 2.20, at wavelength of 589.3 nm. After forming the glass article, at least one surface of the glass article may comprise surface and subsurface defects. The methods disclosed herein further comprise etching the at least one surface of the glass article with an etchant solution to produce an etched glass article. The etching may improve the B₁₀ surface strength of the at least one surface of the etched glass article by removing or rounding the surface and subsurface defects. In embodiments, the etching may cause deposition of transition metal fluorides onto the at least one surface of the etched glass article, such as through reaction of the HF in the etchant solution with transition metals of the HRI glass composition to produce transition metal fluorides. In embodiments, the at least one surface of the etched glass article having the transition metal fluorides deposited thereon may be cleaned with a high pH cleaning solution having a pH of greater than or equal to about 10. The high pH cleaning solution may remove the transition metal fluorides from the at least one surface of the etched glass article to produce an etched and cleaned glass article. The surfaces of the etched and cleaned glass article may have a reduced concentration of transition metal fluorides compared to the surfaces of the etched glass article prior to treating the surfaces with the high pH cleaning solution.

In embodiments, forming the glass article comprising the HRI glass may comprise melting a batch composition comprising HRI glass precursor raw materials to form a molten HRI glass, forming an HRI glass substrate from the molten HRI glass, separating the HRI glass substrate into individual glass articles, and refining the individual glass articles to produce refined glass articles through one or more post-processing refining steps. In embodiments, forming the HRI glass substrate from the molten HRI glass may comprise forming the HRI glass substrate using a slot draw process. In embodiments, the separating the HRI glass substrate into a plurality of individual glass articles may comprise cutting the HRI glass substrate with a cutting tool, such as, but not limited to, a wire saw. In embodiments, refining the individual glass articles to produce the refined glass articles may comprise one or more of lapping, edge shaping, polishing, cleaning, or combinations thereof. Polishing may include a plurality of polishing steps, such as rough polishing, fine polishing, super polishing, where each progressive polishing step further increases the smoothness of the surface. As previously discussed, the cleaning may remove particulates from the surface of the refined glass articles, where the particulates (e.g., polishing particulates, glass particles, or other particulates) are formed in one of the other post-processing refining steps. The refining the individual glass articles may form refined glass articles.

In embodiments, the HRI glass for making the HRI glass articles may comprise transition metal oxides. According to embodiments, the HRI glass may comprise from about 30.0 mol % to about 100.0 mol % transition metal oxides, such as from about 30.0 mol % to about 90.0 mol %, from about 30.0 mol % to about 80.0 mol %, from about 30.0 mol % to about 70.0 mol %, from about 30.0 mol % to about 60.0 mol %, from about 30.0 mol % to about 50.0 mol %, from about 30.0 mol % to about 40.0 mol %, from about 40.0 mol % to about 100.0 mol %, from about 40.0 mol % to about 90.0 mol %, from about 40.0 mol % to about 80.0 mol %, from about 40.0 mol % to about 70.0 mol %, from about 40.0 mol % to about 60.0 mol %, from about 40.0 mol % to about 50.0 mol %, from about 50.0 mol % to about 100.0 mol %, from about 50.0 mol % to about 90.0 mol %, from about 50.0 mol % to about 80.0 mol %, from about 50.0 mol % to about 70.0 mol %, from about 50.0 mol % to about 60.0 mol %, from about 60.0 mol % to about 100.0 mol %, from about 60.0 mol % to about 90.0 mol %, from about 60.0 mol % to about 80.0 mol %, from about 60.0 mol % to about 70.0 mol %, from about 70.0 mol % to about 100.0 mol %, from about 70.0 mol % to about 90.0 mol %, from about 70.0 mol % to about 80.0 mol %, from about 80.0 mol % to about 100.0 mol %, from about 80.0 mol % to about 90.0 mol %, or from about 90.0 mol % to about 100.0 mol % transition metal oxides based on the total moles of the HRI glass composition.

In embodiments, the HRI glass may comprise lanthanum oxide, niobium oxide, tungsten oxide, or combinations thereof. In embodiments, the HRI glass may comprise from about 10.0 mol % to about 40.0 mol % B₂O₃, from greater than or equal to 0 mol % to about 40.0 mol % WO3, from greater than or equal to 0 mol % to about 30.0 mol % Nb₂O₅, from greater than or equal to 0 mol % to about 30.0 mol % TiO₂, from greater than or equal to 0 mol % to about 25.0 mol % La₂O₃, and from greater than or equal to 0 mol % to about 15.0 mol % ZrO₂ based on the total moles of the HRI glass composition. In embodiments, the HRI glass may further comprise from greater than or equal to 0 mol % to about 20.0 mol % Bi₂O₃, from greater than or equal to 0 mol % to about 15.0 mol % TeO₂, from greater than or equal to 0 mol % to about 10.0 mol % PbO, from greater than or equal to 0 mol % to about 10.0 mil % GeO₂, from greater than or equal to 0 mol % to about 10.0 mol % P₂O₅, from greater than or equal to 0 mol % to about 6.0 mol % Y₂O₃, from greater than or equal to 0 mol % to about 5.0 mol % V₂O₅, from greater than or equal to 0 mol % to about 10.0 mol % silica (SiO₂), or combinations of these based on the total moles of the HRI glass composition. In embodiments, the HRI glass composition may comprise greater than or equal to 0.1 mol % WO3, Bi₂O₃, or both. The HRI glass may further include one or more constituents selected from rare earth metal oxides (ReₘOₙ), Al₂O₃, BaO, CaO, K₂O, Li₂O, MgO, Na₂O, SrO, Ta₂O₅, ZnO, and combinations thereof. HRI glass compositions suitable for the methods disclosed herein can be found in co-pending U.S. patent application Ser. No. 17/874,792, filed Jul. 27, 2022, and entitled “BORATE AND SILOCOBORATE OPTICAL GLASSES WITH HIGH REFRACTIVE INDEX AND LOW LIQUIDUS TEMPERATURE,” the entire contents of which are incorporated by reference herein. Other HRI glass compositions may also be suitable for the present methods.

In embodiments, the HRI glass composition may comprise La₂O₃ in an amount greater than about 5.0 mol %, or greater than about 10.0 mol %, or greater than about 15.0 mol %, or greater than 20.0 mol %, or greater than about 25.0 mol %, or greater than about 30.0 mol %, or in a range from about 5.0 mol % to about 40.0 mol %, or in a range from about 10.0 mol % to about 35.0 mol %, or in a range from about 15.0 mol % to about 30.0 mol %.

In embodiments, the HRI glass composition may comprise B₂O₃ in an amount greater than about 5.0 mol %, or greater than about 10.0 mol %, or greater than about 15.0 mol %, or greater than 20.0 mol %, or greater than about 25.0 mol %, or greater than about 30.0 mol %, or in a range from about 5.0 mol % to about 40.0 mol %, or in a range from about 10.0 mol % to about 35.0 mol %, or in a range from about 15.0 mol % to about 30.0 mol %.

In embodiments, the HRI glass composition may comprise WO3 in an amount greater than about 5.0 mol %, or greater than about 10.0 mol %, or greater than about 15.0 mol %, or greater than 20.0 mol %, or greater than about 25.0 mol %, or greater than about 30.0 mol %, or in a range from about 5.0 mol % to about 40.0 mol %, or in a range from about 10.0 mol % to about 35.0 mol %, or in a range from about 15.0 mol % to about 30.0 mol %.

In embodiments, the HRI glass composition may comprise Nb₂O₅ in an amount greater than about 5.0 mol %, or greater than about 10.0 mol %, or greater than about 15.0 mol %, or greater than 20.0 mol %, or greater than about 25.0 mol %, or greater than about 30.0 mol %, or in a range from about 5.0 mol % to about 40.0 mol %, or in a range from about 10.0 mol % to about 35.0 mol %, or in a range from about 15.0 mol % to about 30.0 mol %.

In embodiments, the HRI glass composition may comprise TiO₂ in an amount greater than about 5.0 mol %, or greater than about 10.0 mol %, or greater than about 15.0 mol %, or greater than 20.0 mol %, or greater than about 25.0 mol %, or greater than about 30.0 mol %, or in a range from about 5.0 mol % to about 40.0 mol %, or in a range from about 10.0 mol % to about 35.0 mol %, or in a range from about 15.0 mol % to about 30.0 mol %.

In embodiments, the HRI glass composition may comprise ZrO₂ in an amount greater than about 2.0 mol %, or greater than about 4.0 mol %, or greater than about 6.0 mol %, or greater than 8.0 mol %, or greater than about 10.0 mol %, or greater than about 12.0 mol %, or in a range from about 2.0 mol % to about 15.0 mol %, or in a range from about 4.0 mol % to about 12.0 mol %, or in a range from about 6.0 mol % to about 10.0 mol %.

In embodiments, the HRI glass composition may comprise less than or equal to about 10.0 mol % silica, such as less than or equal to 5.0 mol % silica, less than or equal to 1.0 mol % silica, less than or equal to about 0.75 mol %, less than or equal to about 0.50 mol %, or less than or equal to about 0.10 mol % silica based on the total moles of the HRI glass composition. In embodiments, the HRI glass composition may not comprise silica that has been purposely added to the HRI glass composition.

The HRI glass composition may have a high index of refraction. In embodiments, the refined glass article may have an index of refraction of greater than or equal to about 1.60, or greater than or equal to about 1.70, or greater than or equal to about 1.80, or greater than or equal to about 1.90, or in a range from about 1.60 to about 2.20, or in a range from about 1.70 to about 2.10.

In embodiments, at least one surface of the refined glass article may comprise surface defects, subsurface defects, or both. In embodiments, the surface defects and/or subsurface defects on the surfaces of the refined glass article may comprise micro-cracks or voids, which may be disposed in the refined glass article at a depth of from about 0.1 μm to about 10 μm below the at least one surface of the refined glass article, such as from about 0.1 μm to about 7 μm, from about 0.1 μm to about 5 μm, from about 0.1 μm to about 2 μm, from about 2 μm to about 10 μm, from about 2 μm to about 7 μm, from about 2 μm to about 5 μm, from about 5 μm to about 10 μm, from about 5 μm to about 7 μm, or from about 7 μm to about 10 μm below the at least one surface of the refined glass article.

In embodiments, the surface defects and/or subsurface defects at the surfaces of the refined glass article may limit a surface strength of the refined glass article, as determined from RoR surface strength testing conducted in accordance with the test methods set forth in ASTM: C1499-09. The RoR surface strength of the glass articles is reported herein in units of Newtons (N). For the surface strength testing, the glass articles are round wafers having diameter of about 100 mm, about 150 mm, about 200 mm, or about 300 mm, or the glass articles can be coupons having dimension of about 50 mm by about 50 mm, or about 100 mm by about 100 mm. The wafers and/or coupons for RoR surface strength testing may have a thickness of from about 0.3 mm to about 1.0 mm. The RoR surface strength test data presented herein for HRI glass articles were based on square glass coupons having dimensions of 50 mm by 50 mm and a thickness of 0.6 mm. In embodiments, the surface defects and/or subsurface defects on the surfaces of the refined glass article may limit the B₁₀ surface strength of the refined glass article to less than about 300 Newtons (N). In embodiments, the surface defects and/or subsurface defects on the surfaces of the refined glass article may limit the B₁₀ surface strength of the refined glass article to less than about 250 N, less than about 225 N, less than about 200 N, less than about 175 N, less than about 150 N, or less than about 100 N. In embodiments, the surface defects and/or subsurface defects on the surfaces of the refined glass article may cause the refined glass article to have a B₁₀ surface strength of from greater than 0 (zero) N to about 300 N, such as from about 0.1 N to about 300 N, from about 0.1 N to about 250 N, from about 0.1 N to about 225 N, from about 0.1 N to about 200 N, from about 0.1 N to about 175 N, from about 0.1 N to about 150 N, or from about 0.1 N to about 100 N.

As previously discussed, the methods disclosed herein include etching at least one surface of the refined glass article with an etchant solution to produce an etched glass article. Etching the surfaces of the refined glass articles may comprise contacting the surface of the refined glass article with the etchant solution. The etchant solution may comprise, consist of, or consist essentially of an aqueous solution of HF and, optionally one or more other acids, in water. The other acids may include strong acids such as but not limited to HCl, H₂SO₄, HNO₃, other strong acids, or combinations thereof. In embodiments, the etchant solution may comprise HF and at least one strong acid selected from the group consisting of HCl, H₂SO₄, HNO₃, and combinations thereof. In embodiments, the etchant solution may comprise, consist of, or consist essentially of water, HF, and a strong acid selected from the group consisting of HCl, H₂SO₄, HNO₃, and combinations thereof. In embodiments, the etchant solution may comprise at least HF and water. In embodiments, the etchant solution may comprise HF and an organic acid, such as but not limited to citric acid or tartaric acid.

The etchant solution may comprise a concentration of the HF from about 1 molar (M) to about 8.0 M, wherein the molarity corresponds to the number of moles of the HF contained in one liter of the etchant solution (e.g., an HF concentration of 8.0 M means that one liter of the etchant solution contains 8.0 moles of HF, 0.5 liters of the etchant solution contains 4.0 moles of HF, etc.). When the etchant solution comprises HF and HCl, the etchant solution may comprise a concentration of the HCl from about 2.0 M to about 10.0 M. When the etchant solution comprises HF and H₂SO₄, the etchant solution may comprise a concentration of the H₂SO₄ from about 2.0 M to about 10.0 M. When the etchant solution comprises HF and HNO₃, the etchant solution may comprise a concentration of the HNO₃ from about 2.0 M to about 10.0 M. When the etchant solution comprises HF and HCl, the etchant solution may have a molarity ratio of HF to HCl of from about 1.0 to about 3.0, such as from about 1.0 to about 2.5, from about 1.0 to about 2.0, from about 1.5 to about 3.0, from about 1.5 to about 2.5, from about 1.5 to about 2.0, from about 2.0 to about 3.0, from about 2.0 to about 2.5, or from about 2.5 to about 3.0.

Etching the surfaces of the refined glass articles may comprise contacting the surface of the glass article with the etchant solution comprising HF. Contacting the surface of the refined glass article may comprise submerging the surface of the refined glass article in the etchant solution, spraying or otherwise applying the etchant solution to the surfaces of the refined glass article, or other application method. In embodiments, etching the surfaces of the refined glass article with an etchant solution may comprise contacting the surfaces of the refined glass article with the etchant solution at an etching temperature and for an etching time. In embodiments, etching the surfaces of the refined glass article with the etchant solution may comprise contacting the surfaces of the refined glass article with the etchant solution for the etching time of from about 5 minutes to about 60 minutes, such as from about 5 minutes to about 40 minutes, from about 5 minutes to about 20 minutes, from about 20 minutes to about 60 minutes, from about 20 minutes to about 40 minutes, or from about 40 minutes to about 60 minutes. The etching temperature may be sufficient to etch the surfaces of the refined glass article at a commercially useful etching rate. In embodiments, etching the surface of the refined glass article with the etchant solution comprising HF may be conducted at the etching temperature of from about 20° C. to about 100° C., such as from about 20° C. to about 90° C., from about 20° C. to about 80° C., from about 20° C. to about 60° C., from about 20° C. to about 45° C., from about 25° C. to about 100° C., such as from about 25° C. to about 90° C., from about 25° C. to about 80° C., from about 25° C. to about 60° C., from about 25° C. to about 45° C., from about 45° C. to about 100° C., from about 45° C. to about 90° C., from about 45° C. to about 80° C., from about 45° C. to about 60° C., from about 60° C. to about 100° C., from about 60° C. to about 90° C., from about 60° C. to about 80° C., from about 80° C. to about 100° C., or from about 80° C. to about 90° C.

In embodiments, the methods disclosed herein may comprise etching the surfaces of the refined glass article with the etchant solution at an etching rate of from greater than or equal to 0.01 micrometers/second (“μm/sec”) to about 0.5 μm/sec, such as from greater than or equal to 0.01 μm/sec to about 0.4 μm/sec, from greater than or equal to 0.01 μm/sec to about 0.3 μm/sec, from greater than or equal to 0.01 μm/sec to about 0.2 μm/sec, from greater than or equal to 0.01 μm/sec to about 0.1 μm/sec, from greater than or equal to 0.01 μm/sec to about 0.05 μm/sec, from about 0.05 μm/sec to about 0.5 μm/sec, from about 0.05 μm/sec to about 0.4 μm/sec, from about 0.05 μm/sec to about 0.3 μm/sec, from about 0.05 μm/sec to about 0.2 μm/sec, from about 0.05 μm/sec to about 0.1 μm/sec, from about 0.1 μm/sec to about 0.5 μm/sec, from about 0.1 μm/sec to about 0.4 μm/sec, from about 0.1 μm/sec to about 0.3 μm/sec, from about 0.1 μm/sec to about 0.2 μm/sec, from about 0.2 μm/sec to about 0.5 μm/sec, from about 0.2 μm/sec to about 0.4 μm/sec, from about 0.2 μm/sec to about 0.3 μm/sec, from about 0.3 μm/sec to about 0.5 μm/sec, from about 0.3 μm/sec to about 0.4 μm/sec, or from about 0.4 μm/sec to about 0.5 μm/sec. The etching rate for the etchant solutions may be increased or decreased by increasing or decreasing, respectively, the etching temperature.

In embodiments, etching the surfaces of the refined glass article with the etchant solution may remove from about 1.0 μm to about 10.0 μm of glass from the surface of the refined glass article to produce an etched glass article. In embodiments, etching the surfaces of the refined glass article with the etchant solution may remove from about 1.0 μm to about 8.0 μm, from about 1.0 μm to about 6.0 μm, from about 1.0 μm to about 4.0 μm, from about 1.0 μm to about 2.0 μm, from about 2.0 μm to about 10.0 μm, from about 2.0 μm to about 8.0 μm, from about 2.0 μm to about 6.0 μm, from about 2.0 μm to about 4.0 μm, from about 4.0 μm to about 10.0 μm, from about 4.0 μm to about 8.0 μm, from about 4.0 μm to about 6.0 μm, from about 6.0 μm to about 10.0 μm, from about 6.0 μm to about 8.0 μm, or from about 8.0 μm to about 10.0 μm of glass from the surface of the refined glass article. The etching may include increasing the etching time, the etching temperature, or both to increase the depth of removal of the HRI glass from the surface of the refined glass article. In embodiments, etching the surface of the refined glass article with the etchant solution may improve the B₁₀ surface strength of the surfaces of the etched glass article by removing or rounding the surface and subsurface defects. In embodiments, after etching, the at least one surface of the etched glass article may be washed to remove residual etchant solution from the surfaces of the etched glass article and stop the etching process. The etched glass article may be washed with water to remove the residual etchant solution.

As previously discussed, etching the surfaces of the refined glass article with an etchant solution comprising HF may cause transition metal fluorides, including, but not limited to, LaF₃, to deposit on the surfaces of the refined glass article during etching. After etching with the etchant solution comprising HF, LaF₃ crystals may form on the surface of the etched glass articles and may cover from about 10% to about 100% of the surface area of the etched glass article, such as from about 10% to about 90%, from about 10% to about 80%, from about 10% to about 70%, from about 20% to about 100%, from about 20% to about 90%, from about 20% to about 80%, from about 20% to about 70%, from about 50% to about 100%, from about 50% to about 90%, from about 50% to about 80%, from about 50% to about 70%, from about 70% to about 100%, or from about 70% to about 90%. In embodiments, the methods disclosed herein may further include, after the etching, cleaning the surfaces of the etched glass article with the high pH cleaning solution having a pH of greater than or equal to about 10 to produce an etched and cleaned glass article. Cleaning the surfaces of the etched glass article after etching with an etchant solution comprising HF may remove transition metal fluorides, including, but not limited to, LaF₃, from the surfaces of the etched glass article.

Cleaning the at least one surface of the etched glass article with the high pH cleaning solution may comprise contacting the surfaces of the etched glass article with the high pH cleaning solution. In embodiments, contacting the surfaces of the etched glass article with the high pH cleaning solution may comprise submerging the surfaces of the etched glass article in the high pH cleaning solution at a cleaning temperature and for a cleaning time. In embodiments, contacting the surfaces of the etched glass article with the high pH cleaning solution may comprise spraying the surfaces of the etched glass article with the high pH cleaning solution, or otherwise applying the high pH cleaning solution to the surfaces of the etched glass article. In embodiments, the cleaning temperature may be from about 55° C. to about 70° C., such as from about 55° C. to about 65° C., from about 55° C. to about 60° C., from about 60° C. to about 70° C., from about 60° C. to about 65° C., or from about 65° C. to about 70° C. In embodiments, the cleaning time may be from about 5 minutes to about 20 minutes such as from about 5 minutes to about 15 minutes, from about 5 minutes to about 10 minutes, from about 10 minutes to about 20 minutes, from about 10 minutes to 15 minutes, or from about 15 minutes to about 20 minutes.

In embodiments, the pH of the high pH cleaning solution may be from about 10.0 to about 14.0, or from about 10.5 to about 13.5, or from about 11.0 to about 13.0, or from about 11.5 to about 12.5. In embodiments, the high pH cleaning solution may comprise ammonium hydroxide, sodium hydroxide, potassium hydroxide, a high pH glass cleaning detergent, or combinations thereof. In embodiments, the high pH cleaning solution may comprise a high pH glass cleaning detergent, such as but not limited to SEMI-CLEAN™ KG detergent produced by Yokohama Oils & Fats Industry Co. Ltd., Parker detergent produced by Parker Corporation, Tokyo, JP, or equivalents thereof. Other strong bases or cleaning detergents may also be suitable for the high pH cleaning solution of the present disclosure.

Following cleaning, the surfaces of the etched and cleaned glass articles may be substantially free of transition metal fluorides, such as having a concentration of transition metal fluorides of less than or equal to 1.0 mol %, less than or equal to 0.1 mol %, or even less than or equal to 0.01 mol %. In embodiments, after cleaning, the etched and cleaned glass articles may have transition metal fluorides, such as but not limited to LaF₃, deposited over less than about 10% of the surface area of the etched and cleaned glass articles, such as less than about 5%, less than about 1%, less than about 0.1%, or even less than about 0.01% of the surface are of the etched and cleaned glass articles.

Following forming and post-processing, the refined glass articles may have a root mean square surface roughness (RMS roughness) of less than or equal to 0.5 nanometers (nm). In embodiments, the RMS roughness of the at least one surface of a glass article may be measured using an optical profilometer or atomic force microscopy according to methods known in the art. Etching the refined glass article with an etchant solution comprising HF may increase the RMS roughness of the surfaces of the glass articles. In embodiments, after etching with the etchant solution comprising HF, the RMS roughness of the surface of the etched glass article and/or the etched and cleaned glass article may be greater than the RMS roughness of the surface of the refined glass article prior to etching. In embodiments, the surfaces of the etched glass article and/or cleaned and etched glass article may have an RMS roughness of greater than or equal to about 0.5 nm, such as from about 0.5 nm to about 10 nm. Greater contact time between the etchant solution comprising the HF and the surfaces of the refined glass article during etching may increase the RMS roughness of the surfaces of the etched glass article.

The increase in surface roughness (e.g., RMS roughness) of the etched glass article and/or etched and cleaned glass article may change the optical properties compared to the refined glass article. In particular, the increased surface roughness of the surfaces of the etched glass article may degrade the optical properties of the etched glass article, such as by increasing the waveguide loss of the etched glass article and/or etched and cleaned glass article compared to the refined glass article prior to etching. A waveguide loss of an HRI glass article may indicate the loss in intensity of a beam of light passing through a substrate, such losses being due to scattering or absorption of the light by the substrate. The waveguide loss may be measured using a Metricon Model 2010/M Prism Coupled Refractometer with a waveguide loss attachment. The waveguide loss data reported herein were determined using a wavelength of light of 448 nm and a propagation angle of 41 degrees. The the HRI glass articles tested for waveguide loss were circular discs having a thickness of about 1 cm and a diameter of 100 mm.

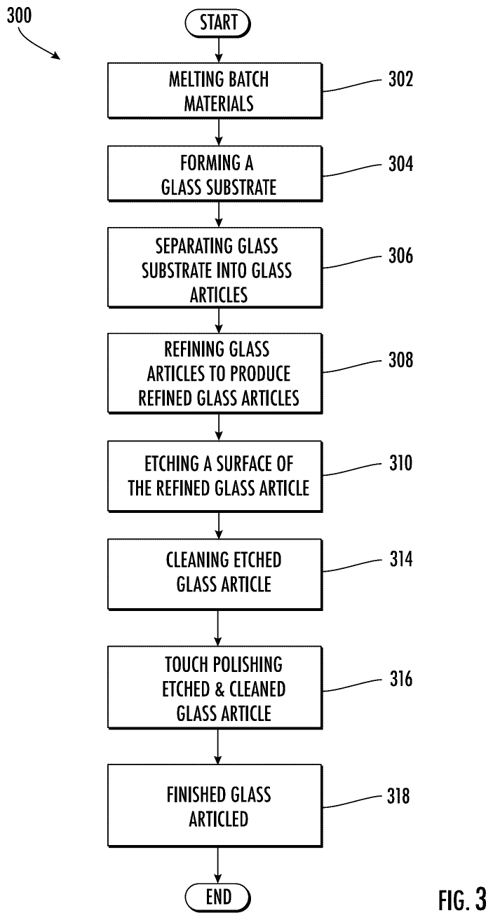

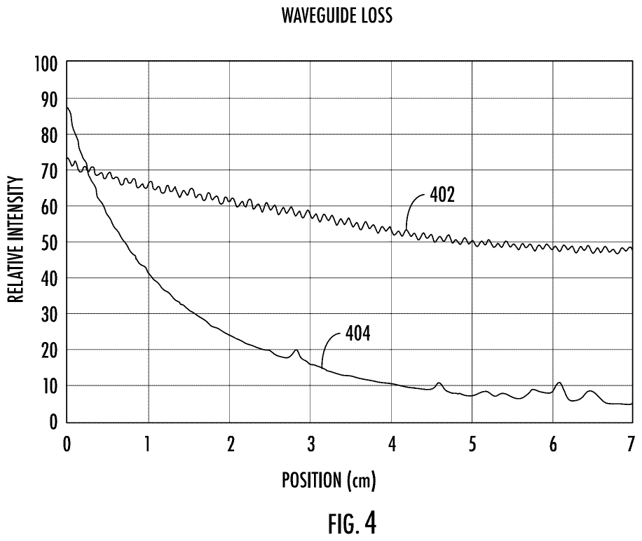

Referring now to FIG. 4, the relative light intensity passed through the glass article is graphically depicted as a function of distance from the prism of the waveguide loss attachment (e.g., the prism through which the light for waveguiding is introduced and the location of which defines a reference position for the guided light) for a refined glass article prior to etching (402) and an etched glass article following etching with an etchant solution comprising HF and then cleaning (404) with the high pH cleaning solution. The loss in wavelength intensity is equal to 100% minus the values depicted in FIG. 4. As shown by data series 402 in FIG. 4, prior to etching, the refined glass article may have a reduction in the intensity of the waveguided light of about 50% at a distance of 7 cm from the point of entry of the guided light into the refined glass article provided by the prism. However, after etching with the etchant solution comprising HF and cleaning with a high pH cleaning solution, the surface of the etched and cleaned glass article exhibited a reduction in relative intensity of the light of greater than 90% at 7 cm from the point of entry of the guided light into the refined glass article provided by the prism, as shown by data series 404 in FIG. 4. The waveguide loss in units of decibels per centimeter can be derived from an exponential fit of the data of relative intensity as a function of distance in FIG. 4 and represents the rate of change of the slope of the intensity vs. distance curves in FIG. 4. The refined glass article (402) prior to etching may have a waveguide loss of from about 0.40 dB/cm to about 0.50 dB/cm, such as about 0.41 dB/cm. For the etched and cleaned glass article (404), the waveguide loss is much greater, as shown by the greater rate of change in the slope of the data series 404. In embodiments, the etched and cleaned glass articles may have a waveguide loss of greater than or equal to 0.70 dB/cm, greater than or equal to 0.75 dB/cm, greater than or equal to 0.80 dB/cm, or even greater than or equal to 0.85 dB/cm. Thus, although etching with an etchant solution comprising HF may increase the B₁₀ surface strength of the etched glass article and may decrease the processing time by increasing the etch rate, the use of HF in the etchant solution may degrade the optical properties of the etched glass article by increasing the RMS roughness.

Touch polishing may be conducted to reduce the RMS roughness of the surfaces of the etched glass articles and/or etched and cleaned glass articles and improve the optical properties thereof. In embodiments, the methods disclosed herein may further include touch polishing the surfaces of the etched glass articles and/or etched and cleaned glass articles to produce finished glass articles. Touch polishing may reduce the RMS roughness of the finished glass articles and may restore waveguide loss performance of the finished glass articles compared to the etched glass articles and/or etched and cleaned glass articles. Accordingly, embodiments of the methods of making a glass articles disclosed herein may further comprise touch polishing the surfaces of the etched glass articles and/or etched and cleaned glass articles to produce finished glass articles. The touch polishing may be conducted for etched and cleaned glass articles that are etched with an etchant solution comprising HF to remediate the increased RMS roughness caused by the high etching rate of HF. In embodiments, the touch polishing may comprise contacting the surfaces of the etched glass articles and/or etched and cleaned glass articles with colloidal silica slurry or solution. In embodiments, the touch polishing may comprise contacting the surfaces of the etched glass articles and/or etched and cleaned glass articles into contact with a slurry comprising of Al₂O₃ or ZrO₂. The pH of the slurry or solution used for touch polishing may be greater than or equal to about 7.0, greater than or equal to about 8.0, greater than or equal to about 9.0, or from about 7.0 to about 12.0, from about 8.0 to about 11.5, from about 9.0 to about 11.0, or from about 9.5 to about 10.5. The slurry for touch polishing may comprises particles of silica, Al₂O₃, ZrO₂, or combinations thereof having an average particles size of from about 20 nm to about 100 nm.

The touch polishing the surfaces of the etched glass articles and/or etched and cleaned glass articles may reduce the RMS roughness of the surfaces of the finished glass articles compared to the etched glass articles and/or the etched and cleaning glass articles. Reducing the surface roughness may further reduce the waveguide loss of the surfaces of the finished glass articles compared to the RMS roughness of the etched glass articles and/or etched and cleaned glass articles prior to touch polishing. After touch polishing, the RMS roughness of the surfaces of the resulting finished glass articles may be about the same or improved relative to the refined glass articles prior to etching. In embodiments, the surfaces of the finished glass articles after etching, cleaning, and touch polishing may have an RMS roughness of less than or equal to about 0.5 nm, less than or equal to about 0.4 nm, less than or equal to about 0.3 nm, less than or equal to about 0.2 nm, or even less than 0.1 nm.

After touch polishing, the waveguide loss of the surfaces of the resulting finished glass articles may be about the same or improved relative to the refined glass articles prior to etching. In embodiments, the finished glass articles after etching, cleaning, and touch polishing may have a waveguide loss of less than or equal to about 0.5 decibels per centimeter (dB/cm), less than or equal to about 0.45 dB/cm, less than or equal to about 0.43 dB/cm, or even less than or equal to about 0.41 dB/cm, where the waveguide loss in dB/cm is obtained by finding the best exponential fit for the graph of relative intensity as a function of distance from the prism output from the Prism Coupled Refractometer with a waveguide loss attachment, previously described herein.

In embodiments, the B₁₀ surface strength of the at least one surface of the etched, cleaned or finished glass articles may be greater than the B₁₀ surface strength of the at least one surface of the refined glass articles (i.e. the refined glass article prior to etching), as measured by RoR surface strength testing. In embodiments, the B₁₀ surface strength of the at least one surface of the etched, cleaned or finished glass articles may be at least about 50% greater than the B₁₀ surface strength of the at least one surface of the refined glass articles prior to etching, as determined by RoR surface strength testing. In embodiments, the at least one surface of the etched, cleaned or finished glass articles may have a B₁₀ surface strength that is at least about 150%, at least about 200%, or at least about 250% of the B₁₀ surface strength of the at least one surface of the refined glass articles prior to etching, as determined by RoR surface strength testing. In embodiments, the surface of the etched, cleaned or finished glass articles may have a B₁₀ surface strength that is from about 150% to about 400%, from about 150% to about 300%, from about 200% to 400%, from about 200% to about 300%, from about 250% to about 400%, or from about 250% to about 300% of the B₁₀ surface strength of the refined glass articles prior to etching, as determined by RoR surface strength testing. In embodiments, the at least one surface of the etched, cleaned or finished glass articles may have a B₁₀ surface strength of greater than or equal to about 400 N, greater than or equal to about 500 N, greater than or equal to about 550 N, or greater than or equal to about 600 N. In embodiments, the at least one surface of the etched, cleaned or finished glass articles may have a B₁₀ surface strength of from about 400 N to about 750 N, from about 500 N to about 700 N, from about 550 N to about 750 N, from about 550 N to about 700 N, from about 600 N to about 750 N, or from about 600 N to about 700 N.

In embodiments, the at least one surface of the finished glass article may have an RMS roughness of less than or equal to about 0.5 nm, less than or equal to about 0.4 nm, less than or equal to about 0.3 nm, less than or equal to about 0.2 nm, or even less than 0.1 nm. In embodiments, the haze of the finished glass article may be less than or equal to about 0.5, such as less than or equal to about 0.4, less than or equal to about 0.3, or even less than or equal to about 0.2, when measured according to the methods provided herein. The haze of surfaces of the finished glass articles may be measured using a haze meter, such as the BYK Gardner Haze-Gard I transparency transmission haze meter, which measures scattering of transmitted light in accordance with ASTM D1003. In embodiments, etching the refined glass articles with an etchant solution comprising HF may change the surface morphology of the surface of the glass article, which may increase the haze of the etched glass articles. In embodiments, the etched glass articles after contact with the etchant solution comprising HF may have a haze of greater than about 0.5. When etching increases the haze, the etched glass articles and/or the etched and cleaned glass articles can be touch polished, as previously discussed herein, to reduce the surface roughness and, therefore, reduce the haze. In embodiments, the finished glass articles may have a haze of from about 0.01 to about 0.50, from about 0.01 to about 0.40, from about 0.01 to about 0.30, from about 0.01 to about 0.20, from about 0.05 to about 0.50, from about 0.05 to about 0.40, from about 0.05 to about 0.30, from about 0.05 to about 0.20, from about 0.10 to about 0.50, from about 0.10 to about 0.40, from about 0.10 to about 0.30, or from about 0.10 to about 0.20.

The surfaces of the finished glass articles may have a specular reflectance excluded (SCE) measurement that is similar to the SCE measurement of the refined glass articles prior to etching. The SCE measurement gives an indication of scattering of reflected light that is reflected from the surfaces of the glass articles. The SCE measurement is a reflective diffusion measurement that is more sensitive than transmitted diffusion (e.g., haze). The SCE measurements may be a diffuse luminous transmittance measurement made with a spectrophotometer with the specular transmission component being removed. In embodiments, the surfaces of the finished glass articles may have an SCE measurement of less than or equal to about 0.10, less than or equal to about 0.09, less than or equal to about 0.08, or even less than or equal to about 0.07. In embodiments, the surfaces of the finished glass articles may have SCE measurements of from greater than zero to about 0.10, from greater than zero to about 0.09, from greater than zero to about 0.08, from greater than zero to about 0.07, from about 0.001 to about 0.10, from about 0.001 to about 0.09, from about 0.001 to about 0.08, or from about 0.001 to about 0.07.

The SCE measurements were made of surfaces prepared to an optical polish using finished glass articles configured as sample disks measuring about 33 mm in diameter×8 mm thick. Equipment and supplies for making such SCE measurements included: a ultraviolet-visible-near infrared (UV-VIS-NIR) spectrophotometer equipped with integrating sphere such as the commercially-available Varian Cary 5G or PerkinElmer Lambda 950 UV-VIS-NIR spectrophotometers appropriately equipped and configured so as to be enabled for SCE measurements in the wavelength range 250-3300 nm (e.g., ultraviolet (UV: 300-400 nm), visible (V: 400-700 nm), and infrared (IR: 700-2500 nm).

Etching with an etchant solution comprising HF may result in different etch rates for different constituents of the HRI glass compositions. In particular, etchant solutions comprising HF may etch zirconia (ZrO₂) at a slower rate compared to the other constituents of the HRI glass composition. Additionally, etching with HF may also leave behind greater concentrations of hydrogen ions in the surface of the glass. As a result, the etched glass articles and/or etched and cleaned glass articles may comprise a surface layer having a composition that is different from the bulk composition of the HRI glass composition, prior to any touch polishing. In embodiments, the surface layer of the etched glass articles and/or etched and cleaned glass articles may have a thickness of from about 1 nm to about 20 nm, from about 1 nm to about 15 nm, from about 1 nm to about 12 nm, from about 1 nm to about 10 nm, from about 1 nm to about 9 nm, from about 1 nm to about 8 nm, from about 1 nm to about 5 nm, from about 5 nm to about 20 nm, from about 5 nm to about 15 nm, from about 5 nm to about 12 nm, from about 5 nm to about 10 nm, from about 5 nm to about 9 nm, from about 5 nm to about 8 nm, from about 8 nm to about 20 nm, from about 8 nm to about 15 nm, from about 8 nm to about 12 nm, from about 8 nm to about 10 nm, from about 9 nm to about 20 nm, from about 9 nm to about 15 nm, or from about 9 nm to about 12 nm. In embodiments, the surface layer may be enriched in ZrO₂, hydrogen, or both, compared to the bulk composition of the HRI glass composition. In embodiments, the surface layer may have a concentration of ZrO₂, hydrogen, or both that is greater than the concentrations of ZrO₂, hydrogen, or both in the bulk glass composition of the etched glass article and/or etched and cleaned glass article.

In embodiments, the surfaces of the finished glass article may be enriched with one or more compounds or elements, as determined by secondary ion mass spectrometry (SIMS) of the glass article surface. In embodiments, the surfaces of the finished glass article may be enriched in zirconia (ZrO₂) compared to the bulk composition of the HRI glass. In embodiments, the surfaces of the glass article may be enriched in ZrO₂ to a depth of up to about 20 nm, up to about 15 nm, up to about 12 nm, or up to about 10 nm. Without being bound by any particular theory, it is believed that ZrO₂ does not react with HF at the same rate as other constituents of the HRI glass and, thus, does not get etched to the same extent as the other constituents in the HRI glass. In embodiments, the surface layer of the finished glass articles may have a maximum concentration of ZrO₂ that is greater than or equal to 140%, greater than or equal to 150%, greater than or equal to 160%, greater than or equal to 180%, or even greater than or equal to 200% of the concentration of ZrO₂ in the bulk composition of the HRI glass. In embodiments, the surface layer of the finished glass articles may have a maximum concentration of ZrO₂ that is from about 140% to about 250%, from about 140% to about 220%, from about 140% to about 200%, from about 140% to about 180%, from about 140% to about 170%, from about 150% to about 250%, from about 150% to about 220%, from about 150% to about 200%, from about 150% to about 180%, from about 150% to about 170%, from about 160% to about 250%, from about 160% to about 220%, from about 160% to about 200%, from about 160% to about 180%, from about 160% to about 170%, from about 170% to about 250%, from about 170% to about 220%, from about 170% to about 200%, from about 170% to about 180%, from about 180% to about 250%, from about 180% to about 220%, from about 180% to about 200%, from about 200% to about 250%, from about 200% to about 220%, or from about 220% to about 250% of the concentration of ZrO₂ in the bulk composition of the HRI glass.

In embodiments, the surfaces of the finished glass articles may be enriched in hydrogen to a depth of up to about 20 nm, up to about 15 nm, up to about 12 nm, or up to about 10 nm. Without being bound by any particular, it is believed that etching with strong acids may cause hydrogen ions to diffuse into the surfaces of the glass articles, thus, resulting in increased hydrogen concentration in the surface layer of the finished glass articles compared to the bulk composition of the HRI glass.

The HRI glass articles produced by the methods disclosed herein may be utilized in optical assemblies, such as but not limited to augmented reality systems, virtual reality devices, mixed reality devices, smart glasses, eye wear, or other optical devices.

### EXAMPLES

The various embodiments of the systems and methods disclosed herein will be further clarified by the following examples. The examples are illustrative in nature, and should not be understood to limit the subject matter of the present disclosure.

For all of the Examples and Comparative Examples herein, the HRI glass articles had the following HRI glass composition: B₂O₃ (33.00 mol %), TiO₂ (9.00 mol %), ZrO₂ (7.00 mol %), Nb₂O₅ (15.00 mol %), La₂O₃ (20.00 mol %), WO3 (16.00 mol %). The composition had an index of refraction of 2.01 at 25° C. for light having a wavelength of 589.3 nm, as measured according to the methods disclosed herein.

### Comparative Example 1

Using conventional fabrication methods, the HRI glass was formed into glass substrates, cut with a wiresaw into individual glass articles comprising wafers having a thickness of 0.6 mm and diameter of 300 mm, and refined to produce refined glass articles. The refining included lapping, edge finishing, course polishing, fine polishing, super polishing, and then cleaning with a high pH cleaning detergent to remove any particulates from the surfaces of the refined glass articles. The refined glass articles were not subjected to etching to remove surface and subsurface defects. Samples of the refined glass articles of Comparative Example 1 were subjected to ball-on-ring and ring-on-ring surface strength testing according to methods disclosed herein. The results of the surface strength testing are provided in FIG. 2. As shown in FIG. 2, the refined glass articles comprising the HRI glass have just over a 10% chance of failure when subjected to a load of 250 N under the Ring-on-Ring surface strength testing (e.g., B₁₀ surface strength of about 250 N).

### Example 2: Etching with HF:HCl Etchant Solution

### I

n Example 2, refined glass articles comprising the HRI glass composition and produced according to Comparative Example 1 were further etched with an etchant solution comprising HF and HCl to improve the surface strength. The etchant solution comprised HF, HCl, and water. The concentration of HF in the etchant solution was 4M, and the concentration of the HCl in the etchant solution was 2M. The refined glass articles were contacted with the etchant solution at 25° C. for an etching time of 30 minutes to produce etched glass articles. The etched glass articles were removed from contact with the etchant solution and rinsed with deionized (DI) water to remove excess etchant solution. The etching rate was 0.022 μm/second and the total amount of material removed by etching from the thickness of the refined glass articles was 5.66 μm, which included 2.83 μm removal from each side of the glass article.

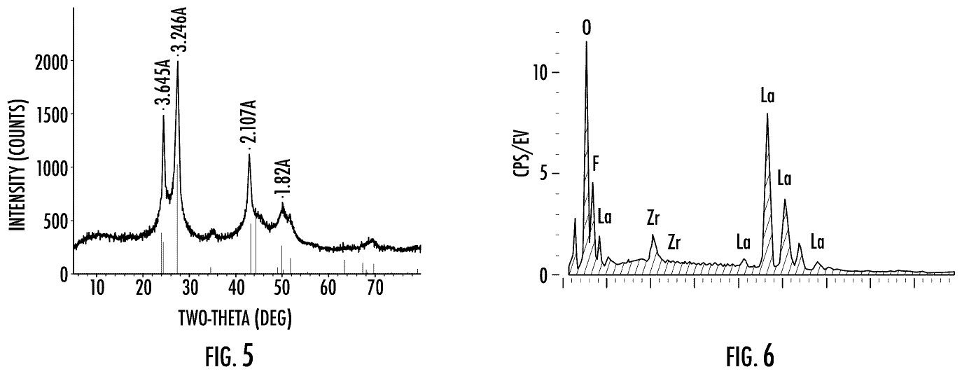

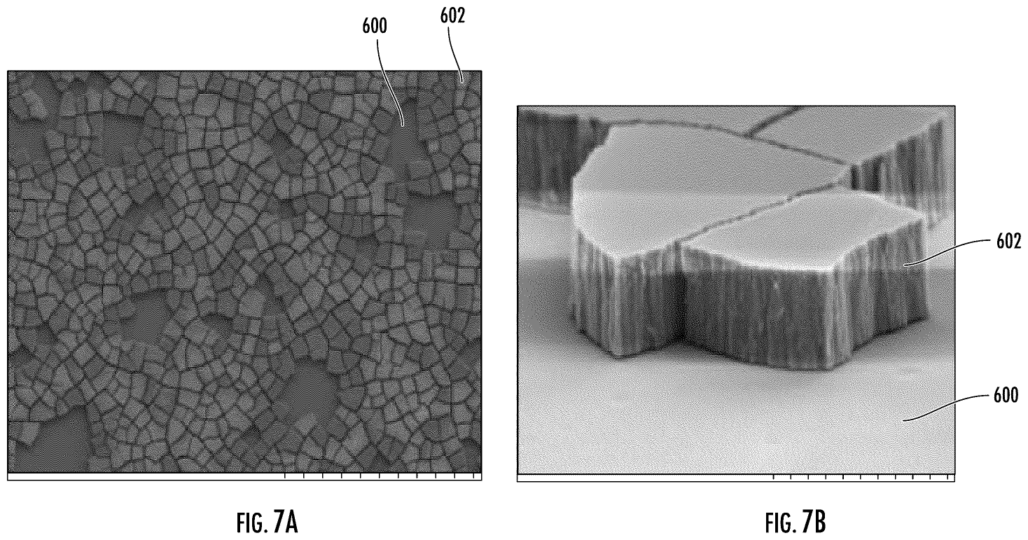

The surfaces of the resulting etched glass articles were then evaluated using X-Ray Diffraction (XRD) and SEM imaging. Referring now to FIGS. 5 and 6, the XRD plots of the surface of the etched glass articles confirm the presence of lanthanum fluoride in precipitates deposited on the surface of the etched glass articles. The elemental analysis in FIG. 6 confirms the presence of Zr and La based fluorides present at the surface of the etched glass articles. Referring now to FIGS. 7A and 7B, SEM images of the surface 600 of the etched glass articles show a layer of precipitates 602 on the surface 600 of the etched glass articles.

### Example 3: Etching Followed by Cleaning with a High pH Cleaning Solution

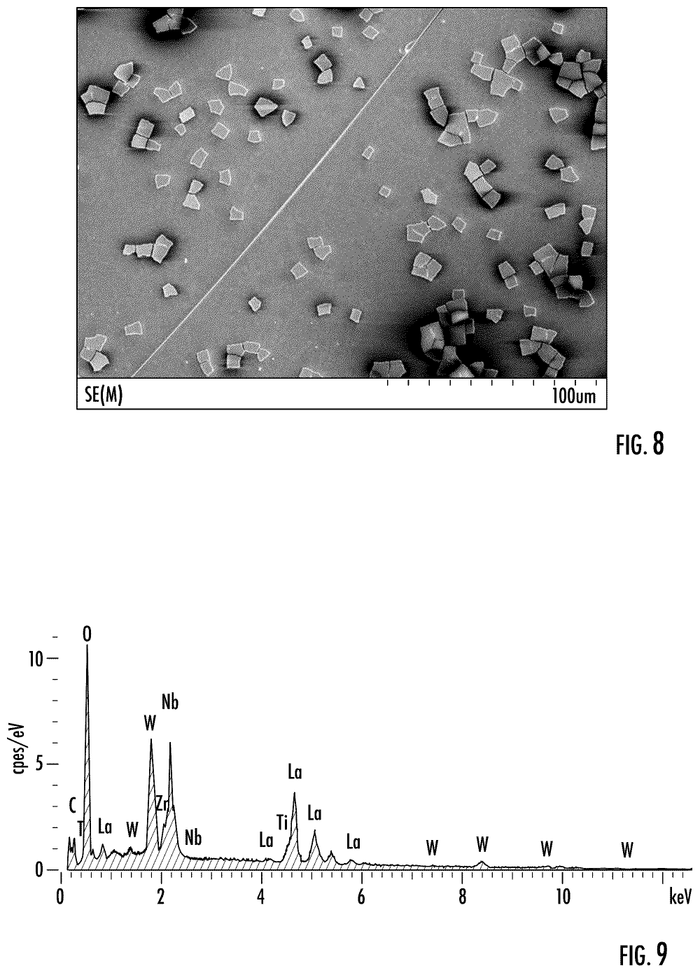

In Example 3, the refined glass articles comprising the HRI glass composition and produced according to Comparative Example 1 were etched with the etchant solution of Example 2 to improve the surface strength and then cleaned with a high pH cleaning solution after the etching to remove the metal fluoride precipitates. The refined glass articles were first etched according to the method described in Example 2 to produce etched glass articles. The etch rate and the material removal were about the same as reported in Example 2. Following the etching, the etched glass articles were then contacted with a high pH cleaning solution comprising 4 parts by mole NH₄OH and 34 parts by mole of deionized (DI) water. The etched glass articles were contacted with the high pH cleaning solution at a temperature of 60° C. and for a cleaning time of 20 minutes to produce etched and cleaned glass articles. The etched and cleaned glass articles were then rinsed with DI water to remove any residual high pH cleaning solution. The surfaces of the etched and cleaned glass articles were then evaluated for the presence of transition metal fluorides deposited on the surface. Referring now to FIG. 8, an SEM image of the surface of the etched and cleaned glass article of Example 3. As shown in FIG. 8, treating the surfaces of the etched glass article with the high pH cleaning solution removed most of the transition metal fluoride deposits on the surface of the etched glass articles, as compared to the deposits shown in FIG. 7A for Example 2. Referring to FIG. 9, an XRD pattern providing an elemental analysis of the surface of the etched and cleaned glass article of Example 3 is graphically depicted. The elemental analysis in the XRD of FIG. 9 shows substantially reduced peak indicative of fluorides compared to the fluoride peak in FIG. 6 for the etched glass article of Example 2. Additionally, the lanthanum peaks are reduced in FIG. 9 compared to FIG. 6, further indicating a reduction in lanthanum fluorides on the surface of the etched and cleaned glass articles of Example 3 compared to the etched glass articles of Example 2.

The etched and cleaned glass articles were further evaluated for waveguide loss according to the methods disclosed herein. Referring again to FIG. 4, the waveguide loss for the refined glass articles of Comparative Example 1 (CE1, ref. 402) and for the etched and cleaned glass articles of Example 3 (E3, ref. 404) are graphically depicted as a function of distance from the prism of the measurement device. As shown in FIG. 4, the etched and cleaned glass articles, which were etched with an etchant solution comprising HF and HCl, exhibited a greater waveguide loss compared to the refined glass articles of Comparative Example 1. Thus, when conducting the etching with an etchant solution comprising HF, touch polishing may be required after the cleaning step to restore the optical properties of the etched and cleaned glass articles back to those of the refined glass articles prior to etching.

### Examples 4-6

For Examples 4-6, HRI glass articles were produced according to the methods disclosed herein and then etched to a different depth in each of Example 4-6. The HRI glass was formed into glass substrates (300 mm diameter, 0.6 mm thick), cut, and finished to produce refined glass articles according to the methods discussed in Comparative Example 1. The refined glass articles were then etched to a depth of 1 μm (Example 4), 3 μm (Example 5), or 5 μm (Example 6) using an etchant solution comprising a concentration of HF of 4M and a concentration of HCl of 4M (an HF:HCl molarity ratio of 4:4) to produced etched glass articles. The etching was conducted at a temperature of 25° C. and the contact time was varied to change the etch depth. The etched glass articles were removed from the etchant solution, rinsed with DI water, and then cleaned with the high pH cleaning solution. Following the etching, the etched glass articles were then contacted with a high pH cleaning solution comprising 4 parts by mole NH₄OH and 34 parts by mole of deionized (DI) water. The etched glass articles were contacted with the high pH cleaning solution at a temperature of 60° C. and for a cleaning time of 20 minutes to produce etched and cleaned glass articles. The etched and cleaned glass articles were then rinsed with DI water to remove any residual high pH cleaning solution.

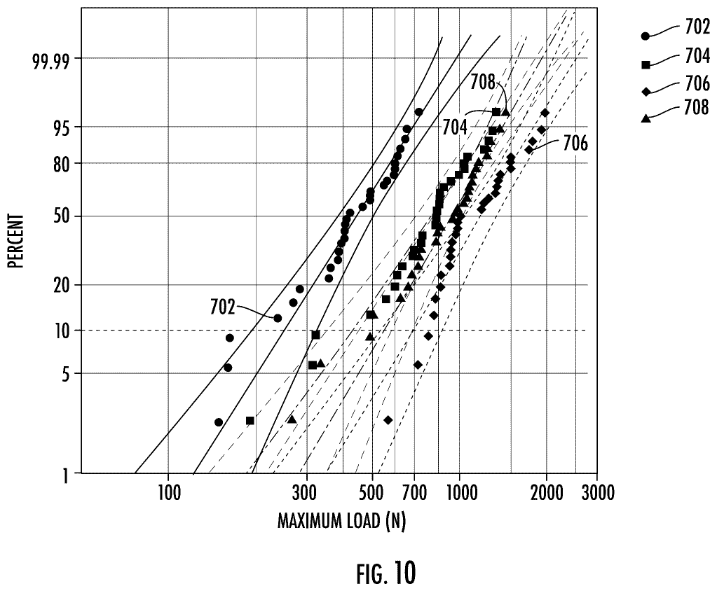

The surface strength for each of the refined glass articles of Comparative Example 1 and the etched and cleaned glass articles of Examples 4-6 was measured using ring-on-ring (RoR) surface strength testing according to ASTM: C1499-09 with a coupon size of 50 mm by 50 mm and a thickness of 0.6 mm. Referring now to FIG. 10, a Weibull plot of the RoR surface strength testing data is graphically depicted. The loads defining the B₁₀ surface strength for the refined glass articles of Comparative Example 1 and the etched and cleaned glass articles of Examples 4-6 are shown in Table 1.

TABLE 1

| | Comparative | | | |
|---|---|---|---|---|
| | Example 1 | Example 4 | Example 5 | Example 6 |
| Reference Number | 702 | 704 | 706 | 708 |
| in FIG. 10 | | | | |
| Data Point Shape | circle | square | diamond | triangle |
| in FIG. 10 | | | | |
| Etch Depth (μm) | 0 | 1 | 3 | 5 |
| B₁₀ Surface | 248.70 | 417.45 | 711.76 | 544.66 |
| Strength (N) | | | | |

The data presented in FIG. 10 and in Table 1 indicate that the B₁₀ surface strengths of the finished glass articles of Examples 4-6 were significantly greater than the B₁₀ surface strength of the refined glass articles of Comparative Example 1. However, the increase in B₁₀ surface strength is shown to vary depending on the depth of etching. The largest improvement in the B₁₀ surface strength was observed for the etched and cleaned glass articles of Example 5, which had an etch depth of 3 μm. The glass articles were further evaluated to determine the crack depth of surface flaws. Referring now to FIG. 11, the check depth of cracks in the surface of the refined glass articles for Comparative Example 1 (CE1) and the etched and cleaned glass articles of Examples 4-6 (E4, E5, and E6) are graphically depicted. As shown in FIG. 11, the shallowest cracks (smallest check depths) were indicated for the etched and cleaned glass articles of Example 5 (E5), for which the etch depth was 3 μm. Without being bound by any particular theory, it is believed that a 1 μm etch depth may be insufficient to remove the surface and subsurface defects resulting from manufacturing, while a 5 μm etch depth may allow deeper diffusion of H⁺ ions, which may accelerate subsurface crack propagation further into the bulk of the glass article. This is supported by the data shown in FIG. 11, which reveal that crack depth was most shallow for E5.

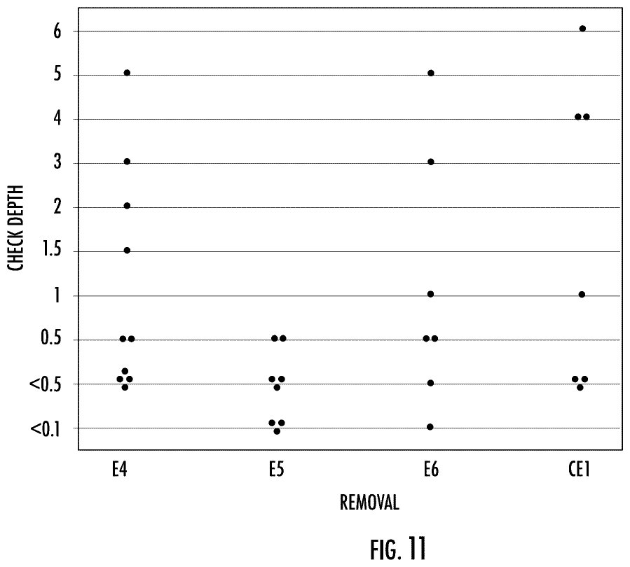

The surfaces of CE1 and E2-E4 (after etching) were subjected to secondary ion mass spectrometry (SIMS) analysis according to the methods discussed herein. Referring now to FIG. 12, the SIMS profiles of the refined glass articles of Comparative Example 1 and the etched and cleaned glass articles of Examples 4-6 showing the zirconium (Zr) concentration as a function of depth within the surface of the glass articles is graphically depicted. As shown in FIG. 12, the concentrations of Zr is generally constant at depths of greater than about 20 nm, which corresponds to the bulk composition of the HRI glass. However, at etch depths of less than 20 nm, the concentrations of the various species vary. For La, Ti, Nb, B, and W, the change in the relative concentration of Zr in the surface layer varies depending on the depth of etching. Referring still to FIG. 12, the concentration profiles for Zr for Comparative Example 1 (ref. 702), and Examples 4-6 (reference numbers 704, 706, 708 from Table 1) are graphically depicted. As shown in FIG. 12, the concentration profile of Zr in the surface layer changes with the etch depth. The surface concentration of Zr is greatest for the etch depth of 3 μm, which was Example 5 (ref. no. 706). The data presented in FIG. 12 suggests that etching glass articles comprising Zr with an etchant solution comprising HF enriches the surface of glass articles in zirconium (that is, the etchant solution creates a surface layer with a concentration of Zr that is greater than the bulk concentration of Zr). Not intending to be bound by any particular theory, it is believed that the enrichment of the surface layer in Zr may result from the HF having a different etch rate for Zr compared to the other constituents of the HRI glass. A similar trend (not shown) was observed for the relative concentration of hydrogen in the various examples. Thus, the SIMS data also suggest that etching a glass article with an etchant solution containing HF results in the glass article being enriched in hydrogen in a surface layer of up to a depth of about 20 nm.

### Examples 7-39

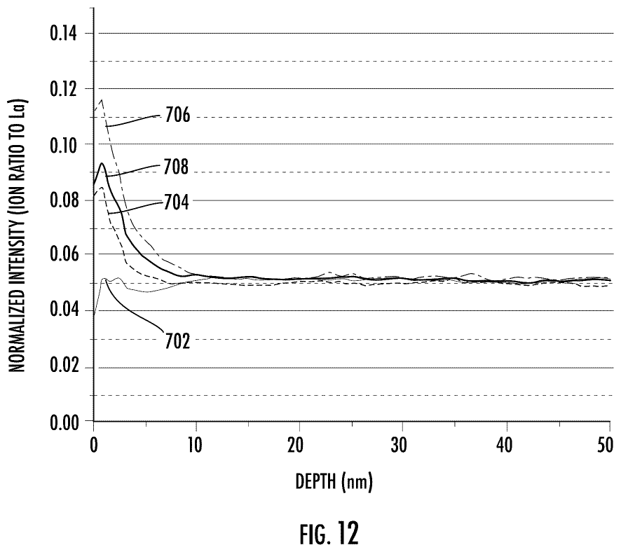

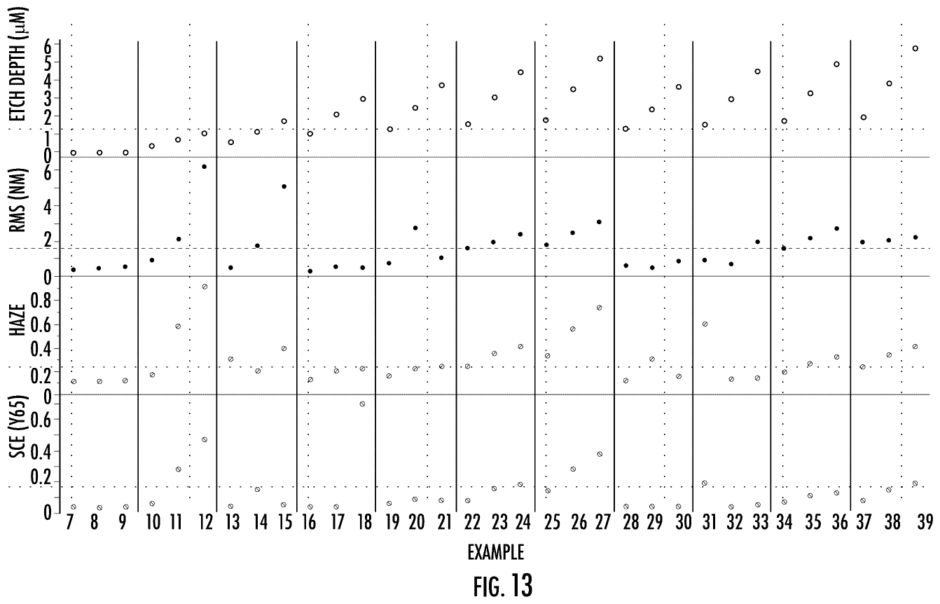

For Examples 7-39, refined glass articles according to Comparative Example 1 (wafers having 300 mm diameter, 0.6 mm thickness) were etched with etchant solutions comprising different concentrations of HCl, HF, or both. The refined glass articles were contacted with the etchant solution at 25° C. for an etching time of 5 minutes, 10 minutes, or 15 minutes. The concentrations of HF and HCl in the etchant solution and the etching time for each of Examples 7-39 are provided in Table 2. The etched glass articles were then cleaned with the high pH cleaning solution as discussed in Example 3. Examples 7-39 were not subjected to touch polishing after cleaning with the high pH cleaning solution. After cleaning, each of the etched and cleaned glass articles were evaluated for the depth of the etching, the RMS roughness of the glass surfaces, the haze, and the SCE. The value used for the SCE was the YD65 value. The data are summarized in FIG. 13.

TABLE 2

| | | | | | | RMS | |
|---|---|---|---|---|---|---|---|
| | | | Etch | Etch | | rough- | |
| | HF | HCl | Time | Depth | | ness | |
| Example | (M) | (M) | (min) | (μm) | Haze | (nm) | SCE(YD65) |
| 7 | 0.0 | 4.0 | 5 | — | — | — | — |
| 8 | 0.0 | 4.0 | 10 | — | — | — | — |
| 9 | 0.0 | 4.0 | 15 | — | — | — | — |
| 10 | 1.0 | 1.0 | 5 | 0.38 | 0.17 | 0.92 | 0.06 |
| 11 | 1.0 | 1.0 | 10 | 0.74 | 0.58 | 2.09 | 0.28 |
| 12 | 1.0 | 1.0 | 15 | 1.08 | 0.92 | 6.23 | 0.47 |
| 13 | 1.0 | 4.0 | 5 | 0.59 | 0.30 | 0.44 | 0.04 |
| 14 | 1.0 | 4.0 | 10 | 1.17 | 0.2 | 1.71 | 0.15 |
| 15 | 1.0 | 4.0 | 15 | 1.74 | 0.39 | 5.09 | 0.05 |
| 16 | 4.0 | 1.0 | 5 | 1.04 | 0.13 | 0.27 | 0.04 |
| 17 | 4.0 | 1.0 | 10 | 2.11 | 0.2 | 0.54 | 0.04 |
| 18 | 4.0 | 1.0 | 15 | 3.00 | 0.22 | 0.48 | 0.70 |
| 19 | 4.0 | 2.0 | 5 | 1.29 | 0.16 | 0.74 | 0.06 |
| 20 | 4.0 | 2.0 | 10 | 2.52 | 0.22 | 2.72 | 0.09 |
| 21 | 4.0 | 2.0 | 15 | 3.75 | 0.24 | 1.03 | 0.08 |
| 22 | 4.0 | 3.0 | 5 | 1.58 | 0.24 | 1.59 | 0.08 |
| 23 | 4.0 | 3.0 | 10 | 3.07 | 0.35 | 1.94 | 0.16 |
| 24 | 4.0 | 3.0 | 15 | 4.48 | 0.41 | 2.37 | 0.18 |
| 25 | 4.0 | 4.0 | 5 | 1.77 | 0.33 | 1.78 | 0.14 |
| 26 | 4.0 | 4.0 | 10 | 3.53 | 0.56 | 2.47 | 0.28 |
| 27 | 4.0 | 4.0 | 15 | 5.27 | 0.74 | 3.11 | 0.38 |
| 28 | 5.0 | 1.0 | 5 | 1.30 | 0.12 | 0.61 | 0.04 |
| 29 | 5.0 | 1.0 | 10 | 2.44 | 0.3 | 0.48 | 0.04 |
| 30 | 5.0 | 1.0 | 15 | 3.64 | 0.15 | 0.86 | 0.04 |
| 31 | 5.0 | 2.0 | 5 | 1.55 | 0.6 | 0.92 | 0.19 |
| 32 | 5.0 | 2.0 | 10 | 2.96 | 0.13 | 0.67 | 0.04 |
| 33 | 5.0 | 2.0 | 15 | 4.49 | 0.14 | 1.98 | 0.05 |
| 34 | 5.0 | 3.0 | 5 | 1.76 | 0.19 | 1.58 | 0.07 |
| 35 | 5.0 | 3.0 | 10 | 3.29 | 0.26 | 2.14 | 0.11 |
| 36 | 5.0 | 3.0 | 15 | 4.93 | 0.32 | 2.68 | 0.13 |
| 37 | 5.0 | 4.0 | 5 | 1.96 | 0.23 | 1.91 | 0.08 |
| 38 | 5.0 | 4.0 | 10 | 3.83 | 0.34 | 2.02 | 0.15 |
| 39 | 5.0 | 4.0 | 15 | 5.82 | 0.41 | 2.21 | 0.19 |

As shown in FIG. 13 and Table 2, the etched and cleaning glass articles of Examples 7-9, which were etched with an etchant solution comprising HCl with no HF, exhibited the lowest RMS roughness, haze, and SCE measurements. However, for Examples 7-9, the etch depth was minimal at an etch time of 15 minutes. The etch depth was not sufficient to improve the B₁₀ surface strength of the etched and cleaned glass articles compared to the refined glass articles prior to etching. As such, when the etchant solution includes only HCl and no HF, the etch time and/or the etch temperature may be increased to increase the etch depth and increase the B₁₀ surface strength. However, increasing the etch time may reduce the manufacturing efficiency of the etching process.

As shown in FIG. 13 and Table 2, the etch depth increased with increasing concentration of HF as shown in Examples 10-39. The etch depth also increased with increasing the total concentration of strong acid, as shown by the trend in Examples 28-39, in which the total amount of the strong acid (HF+HCl) was increased.

The best surface quality was obtained when the molarity ratio of HF/HCl was from 1.5 to 3.0, as in Examples 19-21 (HF:HCl of 4:2) and Examples 31-33 (HF:HCl of 5:2). The modestly high (e.g. 4:2, 5:2, etc.) molarity ratio for HF:HCl led to smoother surfaces (a desirable feature) as indicated by RMS roughness, haze, and SCE measurements in FIG. 13 and Table 2. Referring now to FIG. 14, an SEM image of the surface of the etched and cleaned glass article of Example 21 is provided showing a lack of surface defects, such as LaF₃ deposits, hydration layers, or high surface roughness.

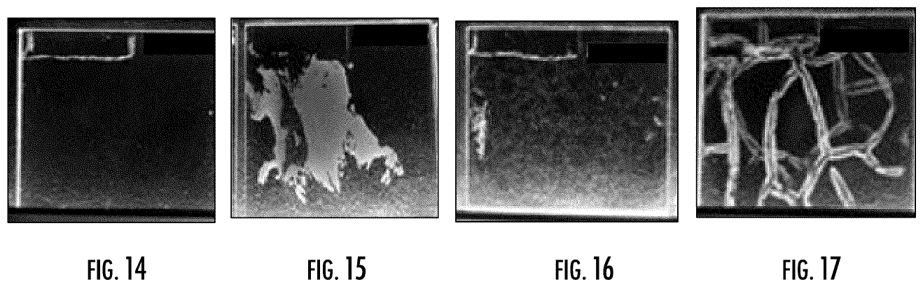

When the ratio of HF/HCl was greater than 2, such as for Examples 16-18 (HF:HCl of 4:1) and Examples 28-30 (HF:HCl of 5:1), the surface roughness was reduced, but the surfaces of the etched and cleaned glass articles exhibited an LaF₃ precipitation layer that could not be effectively removed with the high pH cleaning solution. Referring now to FIG. 15, an SEM image of the surface of the etched and cleaned glass article of Example 18 shows the LaF₃ precipitation layer, which is indicated by the lighter area in FIG. 15. For a ratio of HF:HCl equal to 1, such as for Examples 10-12 (HF:HCl of 1:1) and Examples 25-27 (HF:HCl of 4:4), the etched and cleaned glass articles exhibited increased haze and RMS roughness. The increased roughness is indicated in FIG. 16, which is an SEM image of the surface of the etched and cleaned glass article of Example 27. For a ratio of HF/HCl less than 1, as in Examples 13-15 (HF:HCl of 1:4), the etched and cleaned glass articles exhibited a hydrated film. This hydrated film is shown in FIG. 17, which is an SEM image of the surface of the etched and cleaned glass article of Example 15. Without intending to be limited by any particular theory, it is believed that etching the glass articles with an etchant solution comprising HF but having a ratio of HF/HCl of less than 1 may be hydration dominant, resulting in the formation of the hydrated film on the surface of the glass.

While various embodiments of the methods and HRI glass articles have been described herein, it should be understood that it is contemplated that each of these embodiments and techniques may be used separately or in conjunction with one or more embodiments and techniques.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A method for making a glass article, the method comprising:
etching at least one surface of a glass article with an etchant solution comprising hydrofluoric acid (HF) to produce an etched glass article, the glass article comprising a high index glass, the high index glass comprising transition metal oxides and having an index of refraction of greater than or equal to about 1.60 at a wavelength of 589.3 nm, the at least one surface comprising surface and subsurface defects, wherein the etching improves a B₁₀ surface strength of the at least one surface of the etched glass article by removing or rounding the surface and subsurface defects; and the etching causes the deposition of transition metal fluorides onto the at least one surface of the etched glass article; and
cleaning the at least one surface of the etched glass article with a high pH cleaning
solution having a pH of greater than or equal to about 10.0, wherein the cleaning solution removes the transition metal fluorides from the at least one surface of the etched glass article.

2. The method of claim 1, wherein the etchant solution comprises from about 1 molar (M) to about 8.0 M HF.

3. The method of claim 1, wherein the etchant solution further comprises one or more of HCl, H₂SO₄, or HNO₃.

4. The method of claim 1, wherein the etchant solution comprises HF and HCl in a molar ratio of HF to HCl of from about 1.0 to about 3.0.

5. The method of claim 1, wherein the high pH cleaning solution comprises ammonium hydroxide, NaOH, KOH, a high pH glass cleaning detergent, or combinations thereof.

6. The method of claim 1, wherein the transition metal fluorides comprise LaF₃ and the contacting the etched glass article with the high pH cleaning solution removes the LaF₃ deposited onto the at least one surface of the etched glass article.

7. The method of claim 1, wherein the surface and subsurface defects on the at least one surface of the glass article before etching limits the B₁₀ surface strength of the at least one surface of the glass article to less than or equal to about 250 N, as determined from a ring-on-ring (RoR) test according to ASTM: C1499-09.

8. The method of claim 1, wherein the etching increases the B₁₀ surface strength, as determined from a ring-on-ring (RoR) test according to ASTM: C1499-09, of the at least one surface of the etched glass article by at least about 50% compared to the glass article before the etching.

9. The method of claim 1, wherein the transition metal oxides comprise one or more metal oxides selected from lanthanum oxide, niobium oxide, tungsten oxide, or combinations thereof.

10. The method of claim 1, wherein the high index glass comprises from about 10.0 mol % to about 40.0 mol % B₂O₃, from greater than or equal to 0 mol % to about 40.0 mol % WO3, from greater than or equal to 0 mol % to about 30.0 mol % Nb₂O₅, from greater than or equal to 0 mol % to about 30.0 mol % TiO₂, from greater than or equal to 0 mol % to about 25.0 mol % La₂O₃, and from greater than or equal to 0 mol % to about 15.0 mol % ZrO₂ based on the total moles of the high index glass.

11. The method of claim 1, wherein the high index glass comprises greater than about 15.0 mol % La₂O₃.

12. The method of claim 1, wherein the transition metal fluorides comprise LaF₃.

13. The method of claim 1, wherein the high index glass comprises less than or equal to about 1 mol % silica.

14. A glass article comprising a high index glass, the high index glass comprising greater than about 10.0 mol % La₂O₃ and having a refractive index greater than about 1.60 at a wavelength of 589.3 nm, the glass article having at least one surface with a B₁₀ surface strength, as determined from a ring-on-ring (RoR) test according to ASTM: C1499-09, greater than 300 N.

15. The glass article of claim 14, wherein the high index glass further comprises greater than about 20.0 mol % B₂O₃.

16. The glass article of claim 14, wherein the high index glass further comprises greater than about 4.0 mol % ZrO₂.

17. The glass article of claim 14, wherein the high index glass further comprises greater than about 5.0 mol % TiO₂.

18. The glass article of claim 14, wherein the high index glass further comprises greater than about 10.0 mol % Nb₂O₅.

19. The glass article of claim 14, wherein the high index glass further comprises greater than about 10.0 mol % WO3.

20. The glass article of claim 14, wherein the B₁₀ surface strength is greater than 500 N.
